(19) United States
(12) Patent Application Publication
(10) Pub. No.: US 2013/0166401 A1
(43) Pub. Date: Jun. 27, 2013

(54) REAL TIME INTEGRATED SHOPPING SERVICE

(71) Applicants: Michael Algozer, Chicago, IL (US); Yuan Chiu, Palatine, IL (US); Ashutosh Joshi, Chicago, IL (US); James Marzullo, Oak Brook, IL (US); John Sokel, Chicago, IL (US); Collin Wallace, Chicago, IL (US)

(72) Inventors: Michael Algozer, Chicago, IL (US); Yuan Chiu, Palatine, IL (US); Ashutosh Joshi, Chicago, IL (US); James Marzullo, Oak Brook, IL (US); John Sokel, Chicago, IL (US); Collin Wallace, Chicago, IL (US)

(21) Appl. No.: 13/337,362

(22) Filed: Dec. 27, 2011

(51) Int. Cl. G06Q 30/00

(52) U.S. Cl. 705/16; 705/27.1; 705/26.1

(57) ABSTRACT

A restaurant service monitors order status of member restaurants in near real time using a network of on-site service appliances disposed at the member restaurants. In addition, the on-site service appliances can be integrated with member restaurant point-of-sale systems to provide near real time updates to restaurant menus as they are made in the point-of-sale systems.

### CROSS REFERENCE TO RELATED APPLICATIONS

NONE

### FIELD OF THE INVENTION

The present invention relates to a system and method of providing a retail shopping service, and more particularly relates to a system and method of providing a retail shopping service that provides real-time integration between a member restaurant, a shopping service, and a diner.

### DESCRIPTION OF THE PRIOR ART

Third party shopping catalogues are well known in the art. Such catalogues, distributed by a shopping service, would feature the products of multiple merchants. The catalogue merchant would accept orders and payment from customers. The orders, along with a portion of the payment were sent to product merchants, who would then fulfill the orders. In more recent times, a number of web sites have assumed this model. For example, certain web sites route orders to participating merchants for a fee.

Restaurants traditionally have not participated in shopping services because, unlike non-perishable goods, food generally should be consumed shortly after preparation. However, the adoption of the Internet has made restaurant shopping services feasible, as diners can be given a selection of restaurants within a specified distance of their location. Food can then be delivered to them, or diners can go to the restaurant to pick up their order.

FIG. 1 depicts a prior art restaurant shopping service. Diners 16a,b access the restaurant service through a wide area network 14, such as the Internet. After browsing through a collection of restaurant menus maintained by an order taking server 12 an order is placed and queued into a database 13. Orders are then processed by an order processing server 15. The order processing server utilizes a communication server 18 to transmit a facsimile with the contents of each order to the appropriate restaurant 25. The facsimile is received by the restaurant's 25 fax machine 22, which prints a copy of the order for a restaurant employee to review. After reviewing the order, the restaurant employee uses a telephone 24 to confirm that the order was successfully received; for example, the restaurant service 10 may use an automatic service that calls the restaurant 25, at which time the restaurant employee can enter a code printed on the order.

FIG. 2 is a simplified flow chart describing the workings of a prior art restaurant service like that depicted in FIG. 1. In step 52, an order would be accepted, using, for example, an order taking server. The order would then be processed and in step 54 faxed to the appropriate restaurant. The restaurant service would then wait for a confirmation to be received, or for a maximum time period to elapse in step 56. If the restaurant confirmed receiving the order, the order would be retired in step 58. However, if a maximum time period elapsed, such as, for example, 20 minutes, the order would be escalated in step 60. If an order was escalated, a customer service representative would likely call the restaurant directly. Updates to orders by customers are handled using the same system; i.e., a new order is faxed to the member restaurant, which must confirm the new order.

While the prior art system of FIG. 1 has proven effective in providing reliable service for consumers, it suffers from a long time delay between when the order is sent to the restaurant and when the restaurant service knows the restaurant can prepare it. In addition, updates to orders must go through the same process—there is no way to provide real time updates to the restaurant from the service. In addition, the prior art restaurant service has extremely limited ability to communicate from the restaurant to the restaurant service. Accordingly, important information, such as how long the restaurant will take to prepare the order, or whether a problem with delivery has occurred, cannot be relayed back to the customer in an effective manner.

It should be noted that while a fax system is depicted in FIGS. 1 and 2, other uni-directional systems have been used in the past. For example, email systems have been used, and in some cases, direct connections to delivery service companies have been used as well. However, these systems were also not real-time or even near real-time, and these systems did not allow restaurants to send status information to the restaurant service or to customers.

In addition, many restaurants use point-of-sale systems to ease the checkout process. Point-of-sale systems allow restaurant employees to select actual menu items of the restaurant when taking a customer's order, instead of entering the price; i.e., a restaurant employee would press a button indicating a cheeseburger or a house salad instead of entering a dollar value for either item. However, restaurant services have not had access to menu information used by point-of-sale systems, and instead, have had to build online menus using a physical representation of the restaurant's menu.

### OBJECTS OF THE DISCLOSED SHOPPING SERVICE

An object of the disclosed shopping service is to provide a real time order tracking service for use by a restaurant service and member restaurants;

Another object of the disclosed shopping service is to provide communication from member restaurants to the restaurant service of events affecting the preparation and/or delivery of an order;

Another object of the disclosed shopping service is to provide integration between a restaurant service and member restaurants' point-of-sale systems;

Another object of the disclosed shopping service is to post orders directly to member restaurants' point-of-sale systems;

Another object of the disclosed shopping service is to receive updates to member restaurants' menus through the restaurants' point-of-sale systems;

Other advantages of the disclosed shopping service will be clear to a person of ordinary skill in the art. It should be understood, however, that a system, method, or apparatus could practice the disclosed shopping service while not achieving all of the enumerated advantages, and that the protected shopping service is defined by the claims.

### SUMMARY OF THE INVENTION

By installing an on-site service appliance at member restaurants, a restaurant service can maintain near real time bi-directional communication with a plurality of restaurants. In particular, order information can be acknowledged by member restaurants in near real time and customer changes to orders can be reflected at restaurants in near real time. In one embodiment of the disclosed restaurant service a diner server accepts orders from diners, displays status changes to the diners, and allows the diners to modify or cancel pending orders. A restaurant server communicates the orders, as well as the order changes to an on-site service appliance installed in at least some of the member restaurants. The on-site service appliance allows restaurant employees to see the status of orders in near real time. In addition, the on-site service appliance allows restaurant employees to modify the status of pending orders, or to cancel a pending order that the restaurant cannot fulfill and issue a refund. In an additional refinement, the on-site service appliance can interface with the restaurant's point-of-sale system and capture menu changes, which can then be relayed to the restaurant service in near real-time.

### BRIEF DESCRIPTION OF THE DRAWINGS

Although the characteristic features of this invention will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a simplified system diagram of a prior art restaurant service;

FIG. 2 is a flowchart depicting the order process of a prior art restaurant service;

FIG. 3 is a system diagram of an embodiment of the disclosed restaurant service;

FIG. 4 is a perspective view of a plug computer that is one example of hardware that can be used as an on-site service appliance in the disclosed restaurant service;

FIG. 5 is a flowchart depicting a process by which diners can place orders, modify orders, cancel orders, and check the status of pending orders in accordance with an embodiment of the disclosed restaurant service;

FIG. 6 is a sample display of status information for a pending order as viewed by a diner using a smartphone in accordance with an embodiment of the disclosed restaurant service;

FIG. 7 is a flowchart depicting a process by which new, modified, and/or canceled orders are relayed to member restaurants of a restaurant service in accordance with an embodiment of the disclosed restaurant service;

FIG. 8 is a flowchart depicting a process by which updated menu items are obtained from a restaurant's point-of-sale system and automatically stored within a database of a restaurant service in accordance with an embodiment of the disclosed restaurant service; and

FIG. 9 is a flowchart depicting a process by which order status can be communicated from a restaurant to a restaurant service in accordance with an embodiment of the disclosed restaurant service.

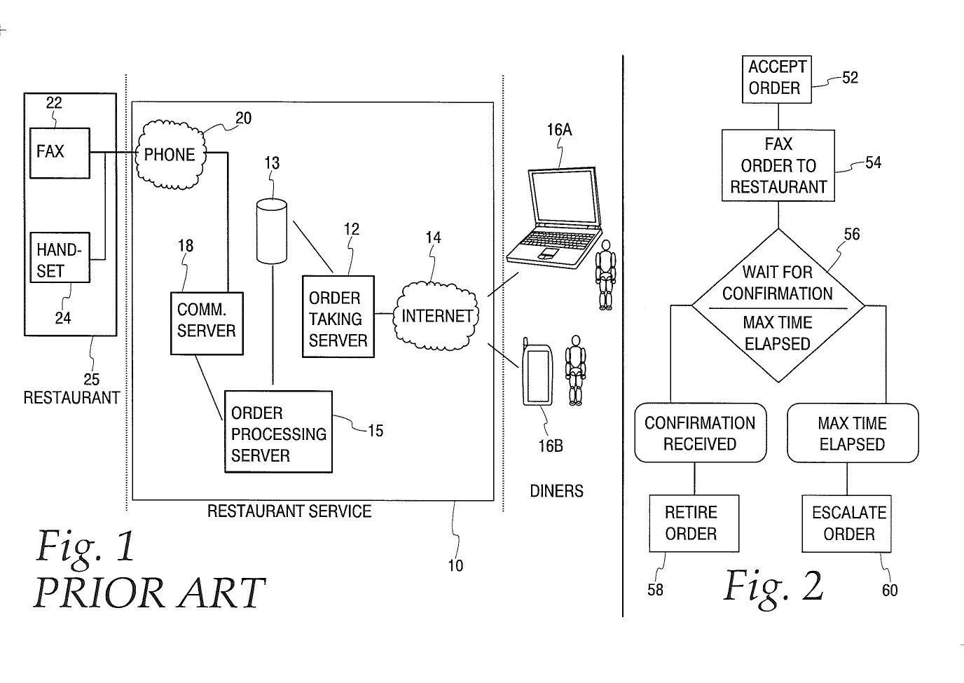

### DETAILED DESCRIPTION OF THE ILLUSTRATED EMBODIMENT

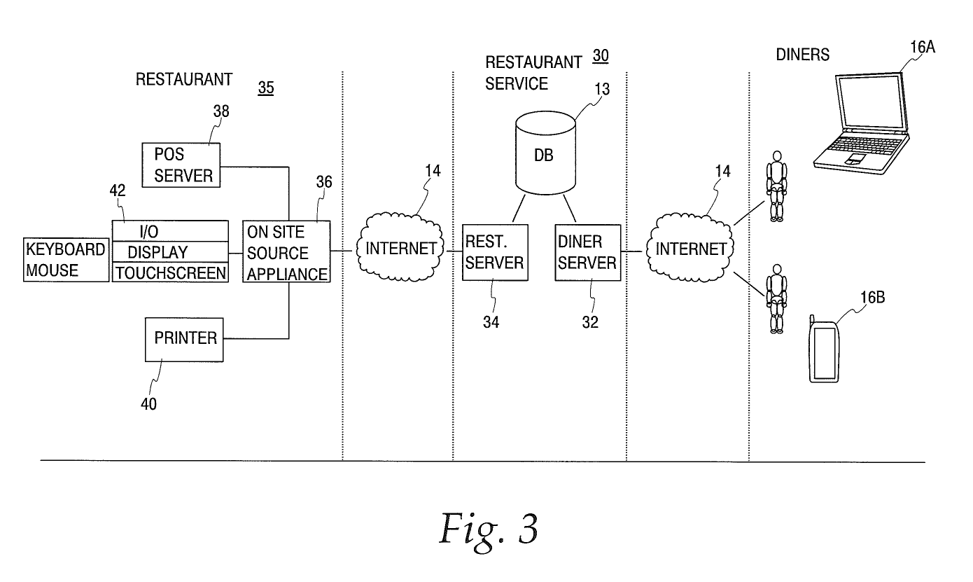

Turning to the Figures and to FIG. 3 in particular, an improved restaurant service is shown. The illustrated restaurant service provides for real time information exchange between the restaurant, the restaurant service, and diners, as well as integration with the restaurant's point-of-sale system (“POS”). As explained herein, integration with the POS will not only enable orders to be posted directly to the POS by the restaurant service, but also will allow the restaurant service to reflect menu changes in real time. As further explained herein, much of this integration is provided through the use of an on-site service appliance.

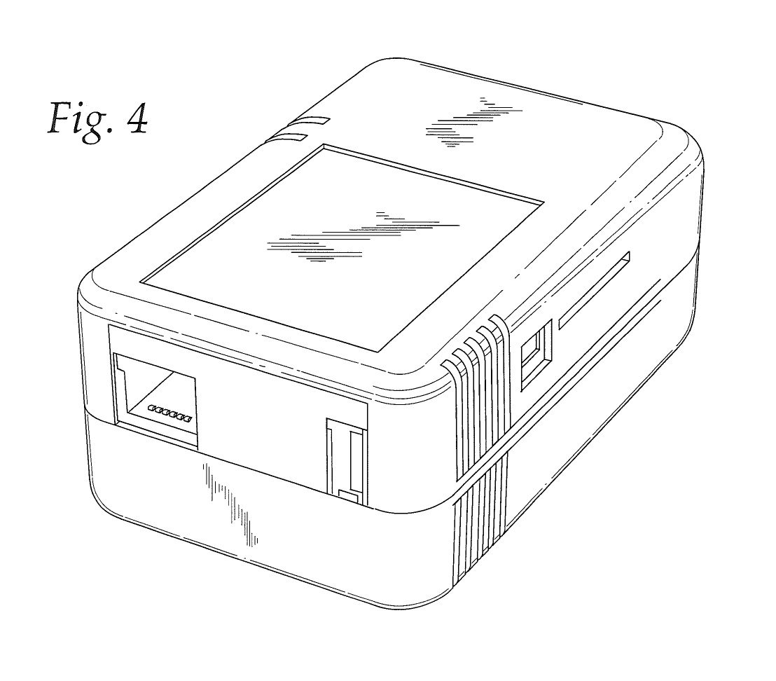

As depicted, diners 16a,b access a restaurant service using, for example, the world wide web or a smartphone, coupled to the Internet 14 or some other wide area network. A diner server 32 interfaces with web diners 16a, smartphone diners 16b, and other diners, using the Internet 14 or another wide area network, and, in response to the diners' inputs, creates, modifies, or cancels orders in database 13. Restaurant server 34, which is also coupled to the Internet 14 or another wide area network, interfaces with an on-site service appliance 36. The on-site service appliance 36 may be, for example, a simple server, such as, for example, a plug computer, like that pictured in FIG. 4. Many models of plug computer can function as an on-site service appliance 36, but in one embodiment, the on-site service appliance may be a MimoPlug Plug Computer having a 1.2 GHz Marvell Sheeva Processor, 512 MB of FLASH memory, and 512 MB of DRAM. In a separate embodiment, instead of a plug computer, one or more tablet computers can be used by the restaurant employees to communicate with the restaurant server 34. The tablet computers can communicate with the restaurant server 34 using any type communications protocol that provide connectivity with the wide area network 14, such as, for example, Internet connected 802.11 (Wi-Fi), or a cellular data connection.

The on-site service appliance 36 can be coupled to a point-of-sale (POS) server 38, so that the on-site service appliance 36 can post orders directly to the restaurant's POS system, as well as monitor menu changes made in the POS system. In addition, the on-site service appliance 36 can be connected to a printer, such as, for example, a thermal printer, and an I/O system, such as a display incorporating a touchscreen, or a mouse and keyboard. The thermal printer can be used, for example, to print incoming orders in kitchen and diner format, as well as allow for reprinting at the restaurant's discretion.

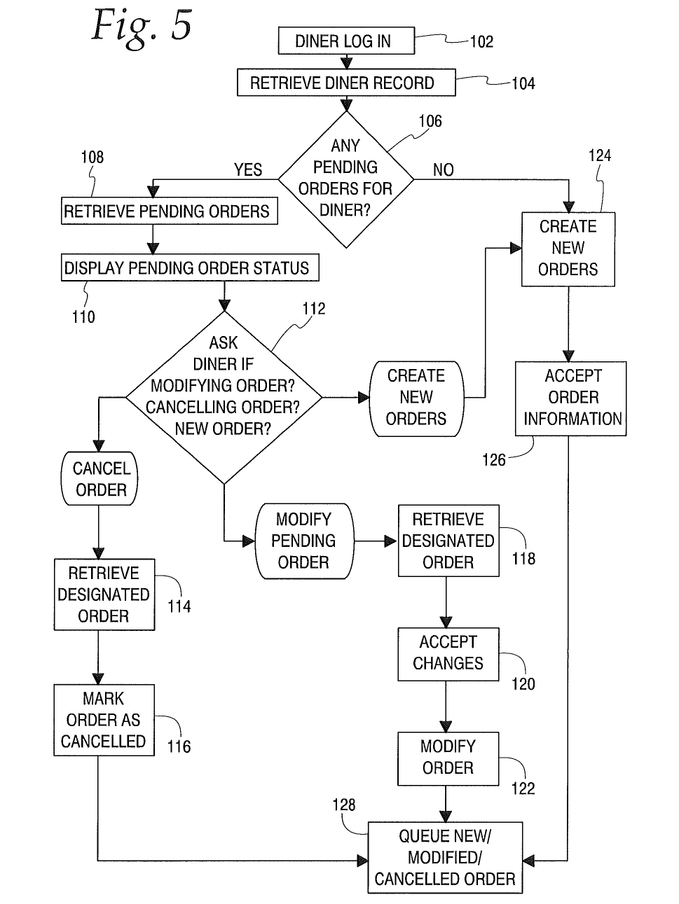

Turning to FIG. 5, a flow chart depicting a diner interaction program operating on the diner server 32 is depicted. In a step 102 a diner “logs in,” which can require the entry of, for example, a user name and password, or may be through some other authentication process, such as through social network authentication or cell-phone authentication. After authentication, execution transitions to step 104, where the appropriate diner record is retrieved from database 13. In step 106 a check is made for any orders associated with the diner. This could include, of course, the diner's entire order history, but for purposes of this disclosure, the query is limited to pending orders. If there are no pending orders, execution transitions to step 124, where a new order structure is created, and to step 126 where the customer enters her order information which is populated into the order structure. The order structure is then placed into a queue maintained by database 13 in step 128.

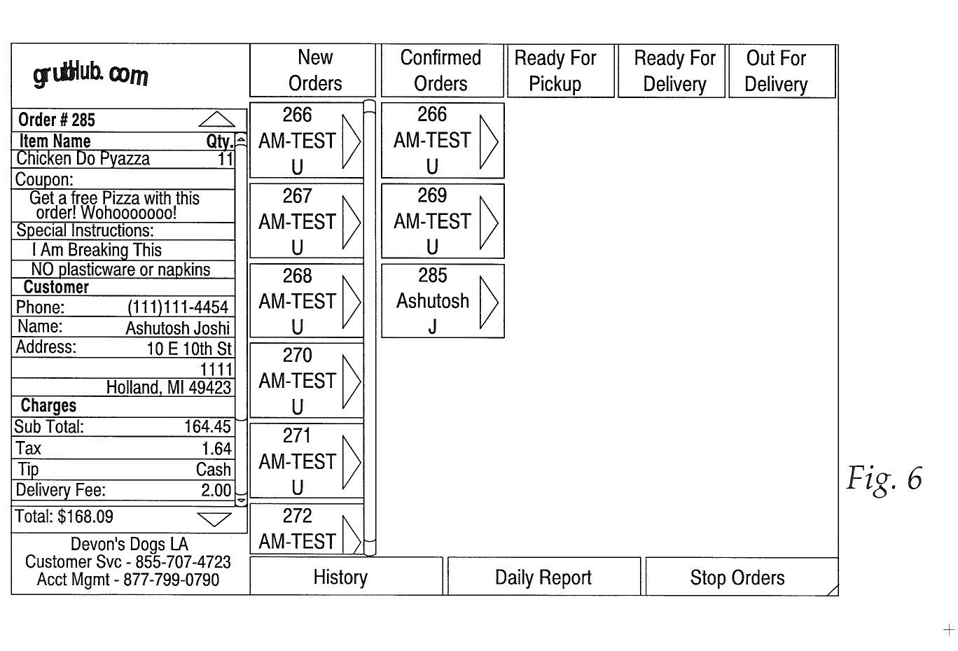

Returning to step 106, if there are pending orders for the diner, execution transitions to step 108, where the pending orders are retrieved. Those orders are then displayed to the diner in step 110. A sample order display is shown in FIG. 6. As depicted order status, metrics, menu information, and system options are displayed. However, other types of information, such as customer support, helpdesk and delivery tracking, can also be displayed.

Execution then transitions to step 112, where a determination is made as to whether the diner is modifying an order, canceling an order, or creating a new order. If the diner is creating a new order, execution transitions to step 124, where execution proceeds as previously discussed. However, if at step 112, the diner decides to cancel a pending order, the order designated by the diner is retrieved in step 114 and marked as canceled in step 116. The canceled order is then queued in step 128.

Returning to step 112, if the diner indicates that she wishes to modify a pending order, execution transitions to step 118, where the order designated by the diner is retrieved. In step 120, the changes the diner wishes to make to the order are gathered, and in step 122 the order is modified with the changes that the diner wishes to make. The modified order is then queued in step 128.

One type of information that the restaurant service can track is diner order status. Depending on whether their order is a pick-up or delivery order, different values of order status can be displayed. For example, in one embodiment of the disclosed restaurant service, the order status for a pickup order can take on one of the following values: unconfirmed, confirmed, ready for pickup, and complete. Similarly, the values for delivery orders can take on the one of the following values in the same embodiment: unconfirmed, confirmed, ready for delivery, out for delivery, and complete.

An order status of unconfirmed means that the restaurant has not confirmed reception of the order, while an order status of confirmed means that the restaurant has confirmed reception of the order. The order status of an order is updated as complete when it has been successfully delivered to the diner or the diner has picked up the order. The remaining order status values are self-explanatory.

Other embodiments of the disclosed restaurant service can, of course, have other possible order statuses. For example, an order that is out for delivery may have additional possible statuses, such as “approaching destination,” if the driver is less than 5 minutes away, or “driver lost,” along with a phone number to call, if the driver requires directions. An obvious extension would be to display the actual position of the delivery vehicle, using, for example, GPS coordinates to track the vehicle.

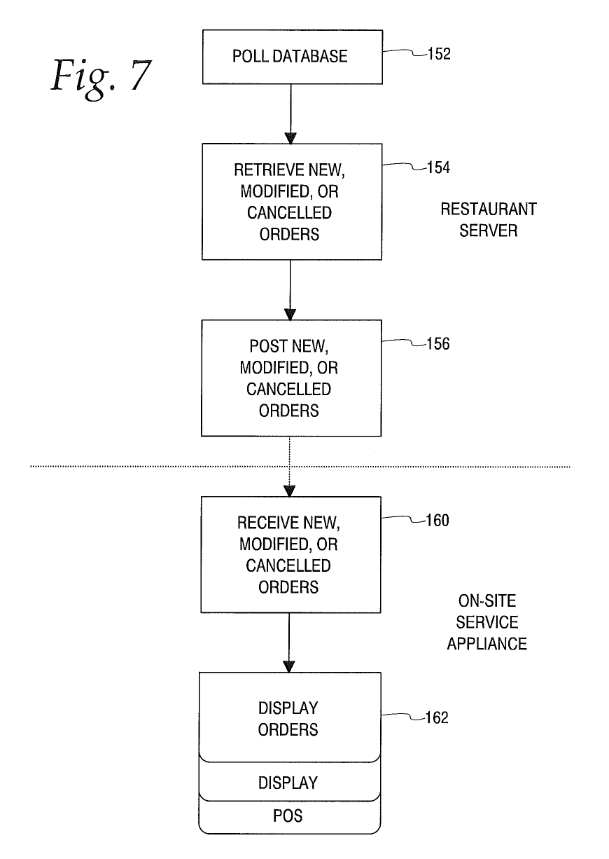

FIG. 7 depicts a process by which new customer orders, modifications, and cancellations are communicated to restaurants. The first part of the process, comprising steps 152-156, is executed by a software program running on the restaurant server 34, while the second part of the process, comprising steps 160-162 is executed by a software program running on the on-site service appliance 36.

In step 152, the restaurant server 34 polls the database 13 to determine if there are any new, modified, or cancelled orders. In step 154, those orders are retrieved, and in step 156, those orders are communicated to the on-site restaurant appliance 36. In step 160, the on-site service appliance 36 receives the new, modified, and/or canceled orders, and in step 162 updated orders are displayed on either or both of the on-site service appliance's 36 display 42, or the POS system 38.

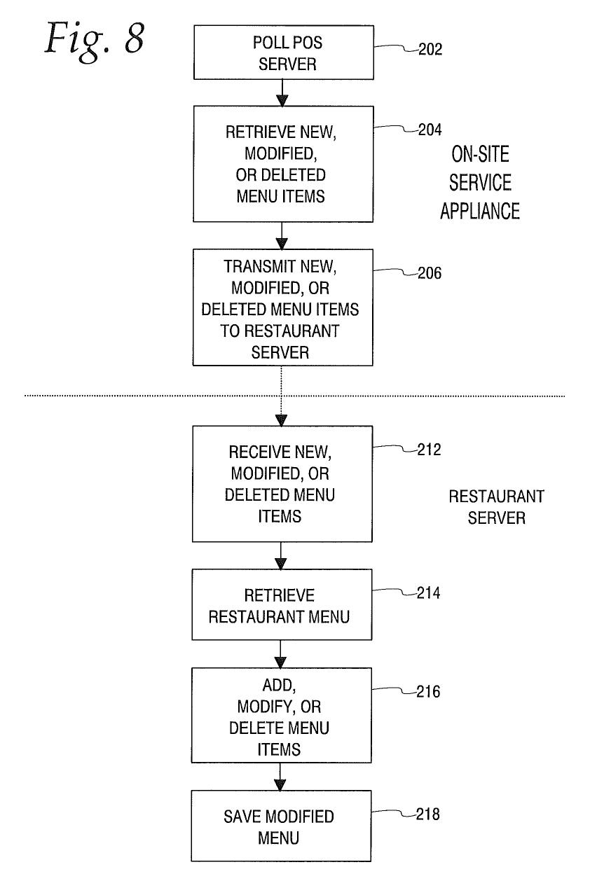

FIG. 8 depicts a process by which menu changes initiated by the restaurant are communicated to the restaurant service. The first part of the process, comprising steps 202-206, is executed by a software program running on the on-site service appliance, while the second part of the process, comprising steps 212-218, is executed by a software program running on the restaurant server 34.

In step 202 the on-site server appliance 36 polls the POS server 38, and retrieves any new, modified or deleted menu items. The new, modified and/or deleted menu items are transmitted to the restaurant server 34 in step 206. In step 212, the restaurant server receives the new, modified, and/or deleted menu items. In step 214, the restaurant's menu structure is retrieved from the database 13 and in step 216, the menu items are added, modified, and/or deleted from the restaurant's menu structure. In step 218, the modified menu structure is stored in the database 13.

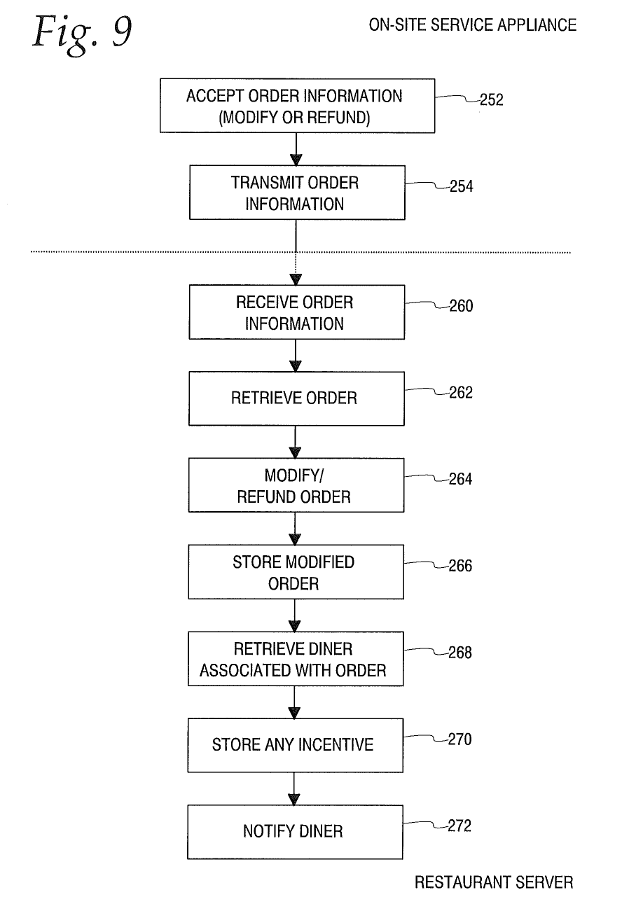

FIG. 9 depicts a process by which a restaurant can modify the status of a particular order and communicate that change to the restaurant service. For example, using this process, a restaurant employee can change the order status for a particular order to confirmed, indicating the restaurant is aware of and working on the order as discussed above. The first part of the process, comprising steps 252-254, is executed by a software program running on the on-site service appliance 36, while the second part of the process, comprising steps 260-272, is executed by a software program running on the restaurant server 34.

In step 252 the on-site service appliance 36 accepts input from a restaurant employee either modifying the status of an order, or refunding an order in the event that a restaurant cannot service the order. In the event that an order is refunded, the diner who made the order may also be credited with an incentive, which can be captured within the order modification, or wrapped into a different structure. In step 254 the modified order (and any incentive) is transmitted to the restaurant server 34.

The restaurant server receives the modified order information in step 260. In step 262, the order is retrieved from the database 13, and appropriately modified or canceled/refunded in step 264. In step 266, the modified order is stored. In step 268, the diner record corresponding to the modified order is retrieved, and any incentive given the diner is credited in step 270. In step 272, a notification is generated for the diner. The notification may be directly sent to the diner by, for example, email or text message by the restaurant server, or it may be sent to the diner server 32, which may send the message to the diner via, for example, email or text message.

Persons of skill in the art will, of course, realize that many variations of the disclosed restaurant service can be implemented. For example, while the diner server and restaurant server were discussed as single servers, they could each, of course, be implemented across multiple servers. In addition, their functions could be combined onto a single server.

Similarly, various software embodiments were discussed within this disclosure. These software embodiments are, of course, merely exemplary, and many variations would be readily apparent to a person of skill in the art informed of this disclosure. For example, some of the disclosed software embodiments reference polling. A person of skill in the art will realize that polling can be replaced with an event or message system. Similarly, a person of skill in the art will realize that the disclosed restaurant service interface service can be implemented on systems other than a web browser operating on a personal computer or a smartphone application. For example, a person of skill in the art, informed of this disclosure, would readily realize that a kiosk placed within a shopping mall or an event venue could also be advantageously used.

Obviously, many additional modifications and variations of the present invention are possible in light of the above teachings. Thus, it is to be understood that, within the scope of the appended claims, the invention may be practiced otherwise than is specifically described above.

The foregoing description of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

What is claimed is:

1. A restaurant service comprising:
i) a database storing a plurality of menus;
ii) a diner server coupled to the database, the diner server adapted to present one or more of the plurality of menus to at least one diner, and to accept an order from the at least one diner, the order corresponding to a particular restaurant;
iii) an on-site service appliance disposed within the particular restaurant;
iv) a restaurant server coupled to the database and adapted to communicate in near real-time with a plurality of on-site service appliances corresponding to a plurality of restaurants, the restaurant server further adapted to transmit the order to the on-site service appliance disposed within the particular restaurant; and
v) the on-site service appliance adapted to transmit an order-status to the restaurant server.

2. The restaurant service of claim 1 wherein the order-status is a cancellation and refund of the order.

3. The restaurant service of claim 2 wherein the order-status includes an incentive for the at least one diner that placed the order.

4. The restaurant service of claim 1 further comprising a point-of-sale system including menu information, wherein the on-site service appliance is adapted to monitor the point-of-sale system for updates to the menu information and to transmit updated menu information to the restaurant server,

5. The restaurant service of claim 1 further comprising a point-of-sale system, and wherein the on-site service appliance is adapted to post the order to the point-of-sale system.

6. The restaurant service of claim 1 further comprising a touch screen coupled to the on-site service appliance, and wherein the order-status is generated from input accepted by the touch screen.

7. The restaurant service of claim 1 further comprising a thermal printer coupled to the on-site service appliance, and wherein the order is printed by the thermal printer.

8. A method of providing status information for a dining order through a restaurant service, the method comprising the steps of:
i) a diner server accepting an order from a diner;
ii) storing the order in a database;
iii) a restaurant server transmitting the order to an on-site service appliance; and
iv) the on-site service appliance transmitting an order-status to the restaurant server.

9. The method of claim 8 wherein the order-status is a cancellation and refund of the order.

10. The method of claim 9 wherein the order-status includes an incentive for the at least one diner that placed the order.

11. The method of claim 8 further comprising the steps of:
i) the on-site service appliance monitoring a point-of-sale system containing menu information for updates to the menu information; and
ii) the on-site service appliance transmitting the menu information to the restaurant server.

12. The method of claim 8 further comprising the step of the on-site service appliance posting the order to a point-of-sale system.

13. The method of claim 8 further comprising the step of accepting input from a touch screen coupled to the on-site service appliance to form the order-status.

14. The method of claim 8 further comprising the step of printing the order at a thermal printer coupled to the on-site service appliance.
